(19) United States
(12) Patent Application Publication
(10) Pub. No.: US 2025/0101995 A1
(43) Pub. Date: Mar. 27, 2025

(54) Ceiling Fan Filter

(71) Applicant: Crestwood Capital, LLC doing business as (d.b.a.) Barnakl, Virginia Beach, VA (US)

(72) Inventors: Peter Finlay, Virginia Beach, VA (US); Kevin Finlay, Virginia Beach, VA (US); Paul Finlay, Virginia Beach, VA (US)

(21) Appl. No.: 18/900,032

(22) Filed: Sep. 27, 2024

Related U.S. Application Data
(60) Provisional application No. 63/585,844, filed on Sep. 27, 2023.

(51) Int. Cl. F04D 29/70; F04D 25/08

(52) U.S. Cl. CPC F04D 29/703; F04D 25/088; F05D 2300/43

(57) ABSTRACT

Provided herein is an air purification filter that includes a collection pad made of an impregnated polyester blend. The collection pad includes a plurality of perforations through which air is configured to pass when the filter is affixed to a rotating fan blade. The impregnated polyester blend comprises a blended polyester material embedded with an air purifying matter. The air purification filter also includes an attachment mechanism coupled to the collection pad configured to secure the collection pad to the fan blade

### CROSS-REFERENCE TO RELATED APPLICATIONS

The present application claims priority to provisional U.S. Application No. 63/585,844 filed Sep. 27, 2023, the contents of which are hereby incorporated by reference in its entirety.

### BACKGROUND

Unless otherwise indicated herein, the description in this section is not believed to be prior art to the claims in this application and is not admitted to be prior art by inclusion in this section.

It can be desirable to eliminate impurities from the air in both residential and commercial settings, as these impurities can have adverse health effect or other negative qualities and consequences. For example, dust, pollen, pet dander, mold spores, dust mites, ragweed, and the like can be allergens, triggering allergies in sensitive people. Airborne smoke particles and volatile organic compounds (VOCs) can also pose a health risk. In the atmosphere, ammonia can bind to other gases to form ammonium which has particularly negative impacts on cardiovascular and respiratory health systems, as well as creating a direct toxic effect on vegetation. An air purifier or air cleaner can reduce these negative effects. An air purifier or air cleaner is any device which removes contaminants from the air to improve air quality.

It would be advantageous to have an air purification device that combines innovative design, advanced filtration technology, and user-friendly functionality to effectively remove airborne contaminants while being seamlessly integrated with ceiling fans, which are likely already installed in most residential and commercial settings. By leveraging existing ceiling fan infrastructure, it would be advantageous to provide a passive, continuous source of air filtration, especially when providing air improvement in areas that people spend most of their time in (bedrooms, living rooms, etc.). This air purification device can offer an economical and practical solution for homeowners seeking to enhance air quality in specific zones of their homes as well as business owners seeking to target specific areas for better air quality in commercial settings. This device can make for a unique and valuable solution for improving indoor air quality without being bulky and/or expensive.

### SUMMARY

This disclosure provides an air purification filter that includes a collection pad made of an impregnated polyester blend. The collection pad includes a plurality of perforations through which air is configured to pass. The impregnated polyester blend is a blended polyester material embedded with an air purifying matter. The air purification filter also includes an attachment mechanism coupled to the collection pad configured to secure the collection pad to a fan blade.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1A is an air purification filter, according to example embodiments.

FIG. 1B is a perspective view of the air purification filter in FIG. 1A, according to example embodiments.

FIG. 2A is a depiction of an attachment mechanism on an underside of the air purification filter in FIG. 1A, according to example embodiments.

FIG. 2B is a depiction of an alternative attachment mechanism on an underside of the air purification filter in FIG. 1A, according to example embodiments.

FIG. 2C is a depiction of an additional alternative attachment mechanism on an underside of the air purification filter in FIG. 1A, according to example embodiments.

FIG. 2D is a depiction of the air purification filter in FIG. 2A undergoing a partial lift when a force is acted on it, according to example embodiments.

FIG. 2E is a depiction of at least one air purification filter attached to an unmoving fan blade, according to example embodiments.

FIG. 2F is a depiction of at least one air purification filter attached to a moving fan blade, according to example embodiments.

FIG. 3A is a depiction of an attachment mechanism in an alternative position on an underside of the air purification filter, according to example embodiments.

FIG. 3B is a depiction of the air purification filter in FIG. 3A undergoing a partial lift when a force is acted on it, according to example embodiments.

FIG. 3C is a depiction of at least one air purification filter attached to an unmoving fan blade, according to example embodiments.

FIG. 3D is a depiction of at least one air purification filter attached to a moving fan blade, according to example embodiments.

FIG. 4A is a depiction of an attachment mechanism on a strip on an underside of the air purification filter, according to example embodiments.

FIG. 4B is a depiction of the air purification filter in FIG. 4A undergoing a partial lift when a force is acted on it, according to example embodiments.

FIG. 4C is a depiction of at least one air purification filter attached to an unmoving fan blade, according to example embodiments.

FIG. 4D is a depiction of at least one air purification filter attached to a moving fan blade, according to example embodiments.

### DETAILED DESCRIPTION

Example systems of an air purification filter and methods of use thereof are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are within the scope of what is contemplated herein. In addition, the particular arrangements shown in the figures should not be viewed as limiting. It should be understood that other embodiments might include more or less of each element shown in a given figure. Additionally, some of the illustrated elements can be combined or omitted. Yet further, an example embodiment can include elements that are not explicitly illustrated in the figures.

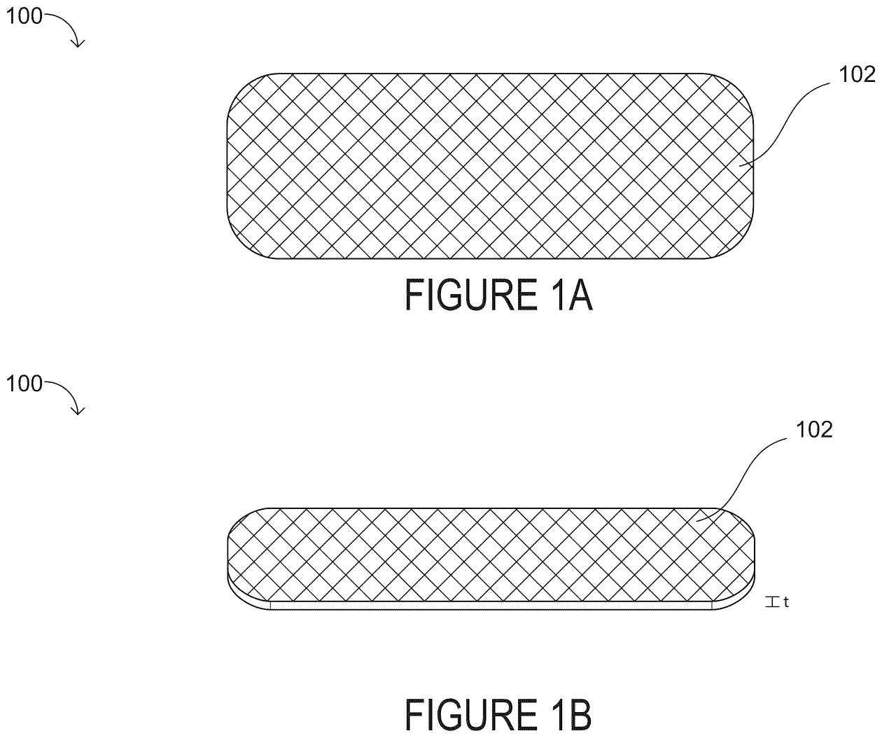

FIGS. 1A-1B depict an air purification filter 100, according to example embodiments. In example embodiments, the air purification filter 100 is lightweight enough, durable enough, and made from high-enough-quality materials to withstand persistent airflow generated by a fan to which it is attached. In such embodiments, a material for the air purification filter 100 is selected such that these features are accomplished.

The air purification filter 100 includes a collection pad 102. The collection pad 102 can be made of an impregnated polyester blend having a plurality of perforations through which air is configured to pass. In some embodiments, the impregnated polyester blend is a blended polyester material embedded with an air purifying matter. An impregnated material is generally any material that has been treated in order to accomplish certain material properties, such as lining, filling, imbuing, permeating, or saturating a porous substrate with an impregnating agent. For instance, an impregnated fabric material is any fabric material in which the spaces between the yarns are completely filled with, or impregnated with, another material such as a polymer, adhesive, paint, or other substance. Further, for example, the collection pad 102 can include a non-woven polyester fabric that has been impregnated with one or more advanced filtration materials. The one or more advanced filtration materials can include an activated coconut shell carbon, a zeolite (a microporous, three-dimensional crystalline solid of aluminum silicate), a blend of the aforementioned, an alumina potassium, or another material capable of purifying the air.

For instance, activated coconut shell carbon is a highly active/highly porous coconut shell carbon having more than 1200 m²/gram surface area. This activated coconut shell carbon can be used to target for removal from air substance including acetic acid, acetones, alcohols, aldehydes, amines, benzine, chlorine, chlorine dioxide, hydrocarbons and volatile organic compounds (VOCs), hydrogen bromide, hydrogen chloride, hydrogen fluoride, mercaptans, organic acids, toluene, xylene, or other air pollutants and toxins. Zeolite, can be used to target ammonia (NH₃) and ammonium (NH₄⁺) ions or salts. Alumina potassium (A/K Series) can be used to target acetic acid, acetones, alcohols, aldehydes, ammonia, arsine, chlorine, ethylene, formaldehyde, hydrocarbons and VOCs, hydrogen bromide, hydrogen chloride, hydrogen fluoride, hydrogen sulfide, nitrogen oxide, nitrogen dioxide, organic acids, sulfur dioxide, or other air pollutants and toxins. Further, in some embodiments, the air purification filter can be impregnated with any one of these materials, or with any combination of these materials. By impregnating the blended polyester material with a combination of these materials—such as both activated coconut shell carbon and zeolite—the air purification filter can be dual-purposed to utilize a range of contaminant absorption in conjunction with absorption of ammonia and ammonium simultaneously.

The air purification filter 100 can further include a variety of sizes, ranging from relatively large to relatively small in comparison to the length of a blade of a standard fan. In some embodiments, the air purification filter 100 can be sized to be universally fit onto a standard sized fan blade. As such, the air purification filter 100 can be designed to be universally compatible with various types and sizes of ceiling fans so that it fits seamlessly onto most standard fan blades. The universal compatibility makes it suitable for use in a wide range of residential and commercial applications. For instance, most ceiling fans are between 42 and 48 inches in diameter and have blades between 12 and 22 inches long. As such, the air purification filter 100 can have a length of approximately 10 inches and a width of approximately 3.5 inches, which is compatible with many standard ceiling fans. In other embodiments, the air purification filter can have a length of approximately 20 inches and a width of approximately 5.5 inches, which would be compatible with larger ceiling fans. Further, the air purification filter 100 can be rectangular, ovular, or the like. Other shapes and sizes of air purification filter 100 are possible. Further, in some embodiments, the air purification filter 100 can include a thickness t. The thickness t can include ⅛ inch, ¼ inch, ½ inch, 1 inch, or any other thickness. The larger thicknesses may allow the filter to gather more air impurities because there is a greater surface area for the air to flow through. In some embodiments, because the material of air purification filter 100 can bend and flex, this flexibility can further allow for a universal fit on fan blades on various sizes, shapes, and contorts.

In some embodiments, more than one air purification filter can be applied to the same blade of the fan. In other embodiments, only one air purification filter can be applied to a blade of a fan at a time. Although ceiling fans are depicted throughout this application, it is also contemplated that the air purification filter 100 can also be installed on oscillating fans or any other type of fan or rotating device as well.

In some embodiments, the air purification filter 100 is designed to optimize airflow while maintaining its air purification capabilities. The design incorporates perforations and channels that facilitate the smooth passage of air through the air purification filter 100, thereby optimizing the impurities in the air that the air purification filter 100 is able to capture. This can help ensure that a fan's performance on which that air purification filter 100 is attached is not compromised while the filter is attached.

In some embodiments the air purification filter 100 can be designed to have a predetermined Minimum Efficiency Reporting Value (MERV) rating. The MERV rating is a measurement scale designed in 1987 by the American Society of Heating, Refrigerating and Air-Conditioning Engineers (ASHRAE) to report the effectiveness of air filters in more detail than other ratings. The MERV rating signifies an air filter's effectiveness at reducing airborne particles and contaminants. The air purification filter 100's MERV rating is determined by the minimum size particle the filter is capable of trapping (measured in microns). The MERV rating increases as filters become better at improving indoor air quality. In some embodiments, based on the blended polyester material and the impregnating material chosen, the air purification filter 100 can have a MERV rating between 5 and 10. In such embodiments, each perforation of the plurality of perforations included in air purification filter 100 has a diameter configured to receive particulates between 0.1 to 100 microns large. Further, in such embodiments, each perforation of the plurality of perforations included in air purification filter 100 has a diameter configured to receive spores between 4 to 6 microns in size.

Further, in some embodiments, the collection pad 102 portion of the air purification filter 100 can be detachable to allow for regular maintenance and filter replacements. Therefore, in some embodiments, air purification filter 100 can be designed to allow the collection pad 102 component to be easily detachable from an attachment mechanism, attaching the collection pad 102 to the blade of the fan, permitting convenient replacement when needed. This can improve performance and air purification of the air purification filter 100.

The air purification filter 100 further includes an attachment mechanism coupled to the collection pad 102. The attachment mechanism secures the collection pad 102 to a fan blade. The attachment mechanism can be any attachment mechanism able to secure the collection pad 102 to the blade of the fan semi-permanently, as described in this application. Accordingly, when the fan is powered on, at least a portion of the collection pad 102 is able to maintain contact with the blade of the fan, via the attachment mechanism, without losing connection thereto or flying off the blade. However, when desiring to replace the collection pad 102, the attachment mechanism can be designed to ease the transition from the old collection pad 102 to the new collection pad 102 without having to remove the attachment mechanism from the blade of the fan.

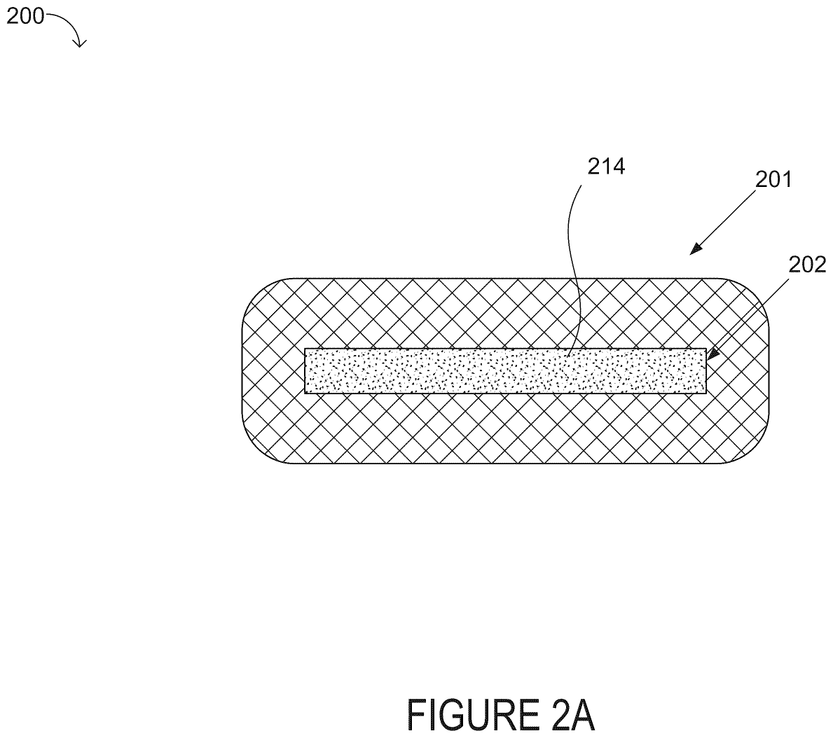

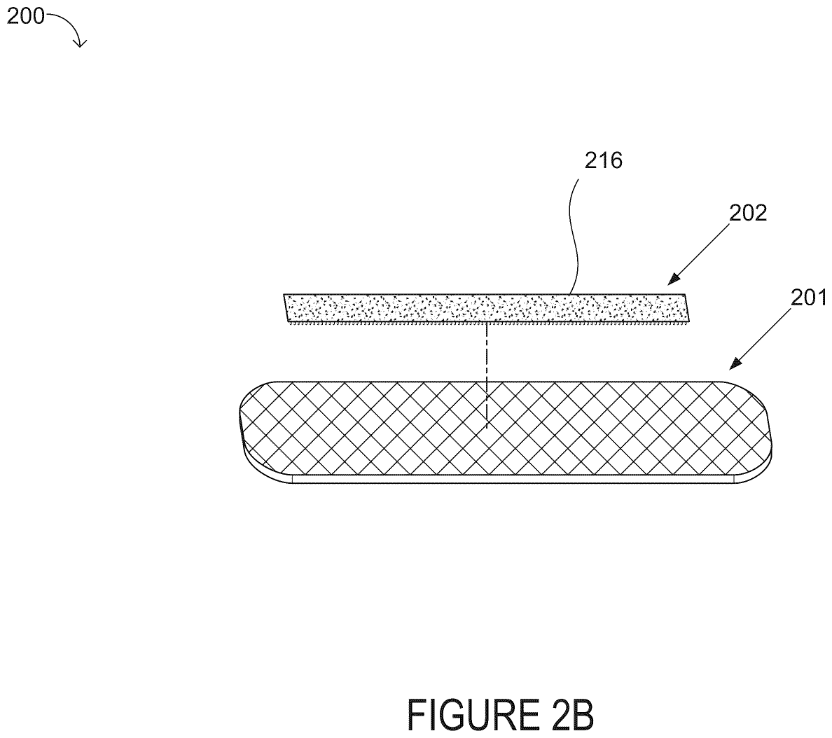

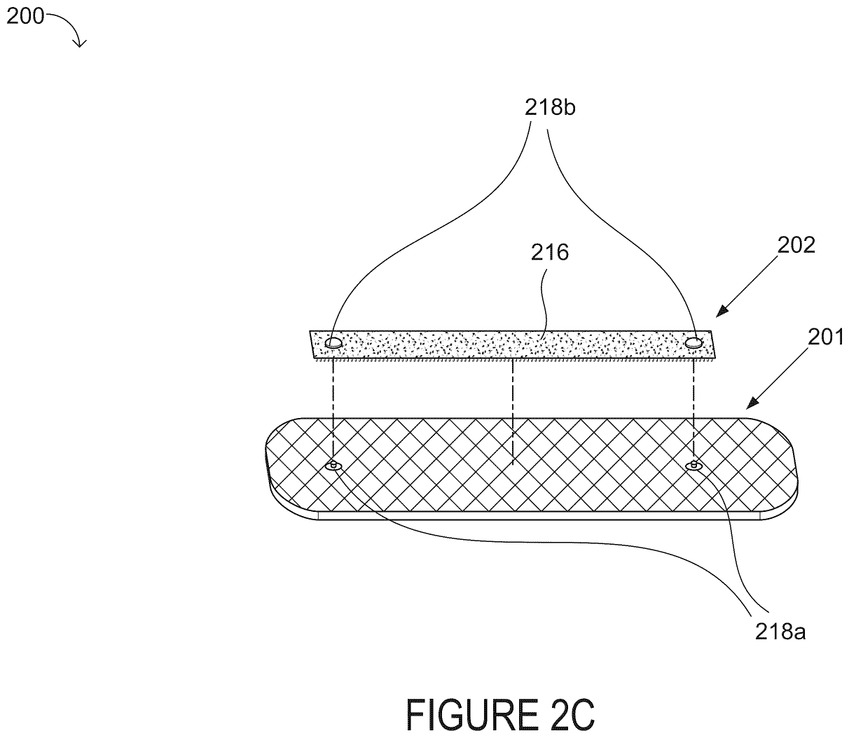

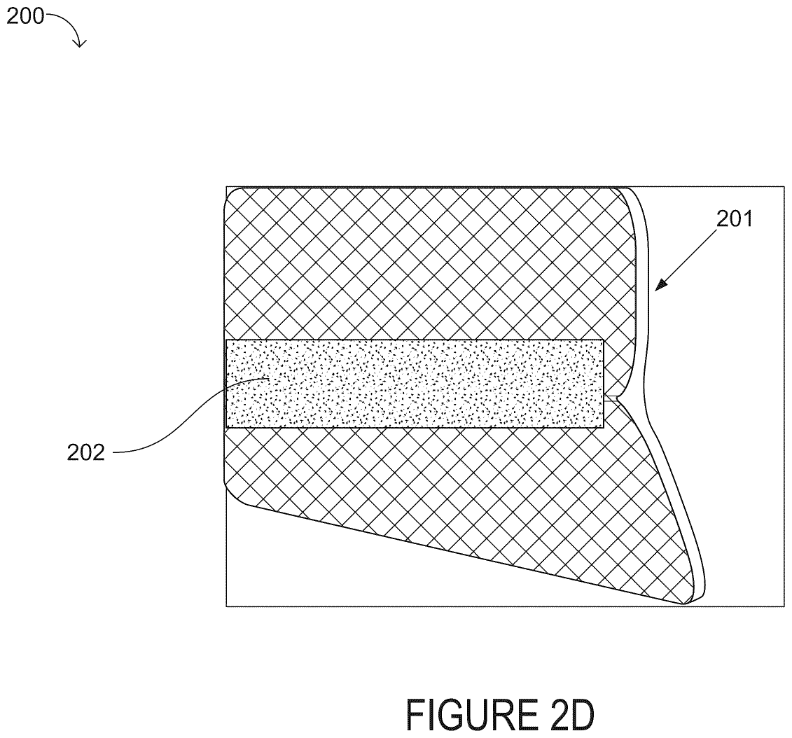

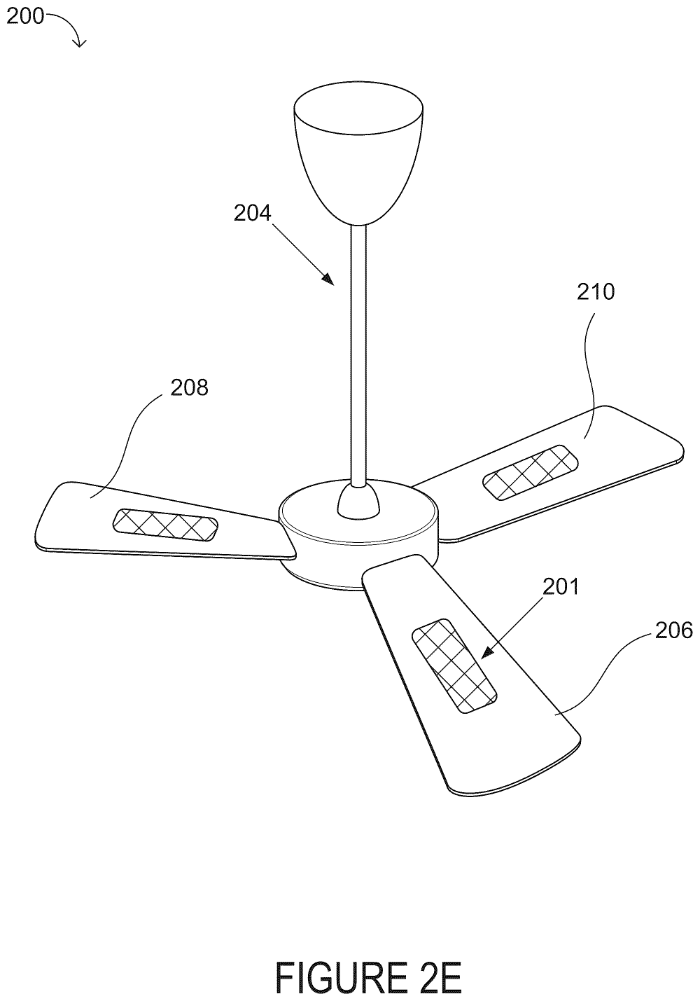

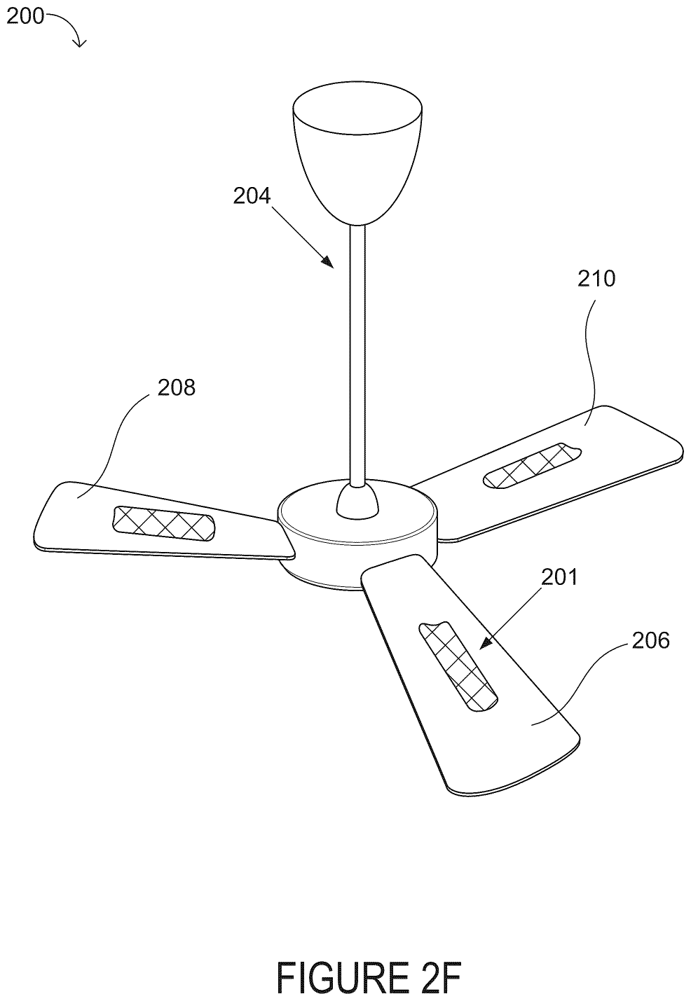

For example, in some embodiments, the attachment mechanism is an adhesive strip. In such embodiments, the adhesive strip runs along a length of the collection pad 102. In other embodiments, the adhesive strip runs along a portion of a length of the collection pad 102. In some embodiments, the attachment mechanism is a plurality of adhesive strips. In some embodiments, the adhesive strip and/or the adhesive strips are removable from the collection pad 102 and/or the blade of the fan. Other attachment mechanisms of air purification filter 100 are also possible. The adhesive strip can be the attachment mechanism 202 as described in FIG. 2A.

In some embodiments, the attachment mechanism includes a hook fastener wherein the hook fastener comprises an adhesive side and a teeth side opposite the adhesive side. The teeth side can be coupled to the collection pad 102 and the adhesive side of the hook fastener can be coupled to the blade of the fan. The collection pad 102 is affixed to the blade of the fan via the hook fastener. In some embodiments, the teeth side of the hook fastener is coupled to an underside of the collection pad 102 wherein the teeth side of the hook fastener is adjacent to a center of the underside of the collection pad 102. In such embodiments, a partial lift is capable of being generated when the fan is powered. Particularly, when the fan is powered on approximately half of the collection pad 102 can undergo a facial lift in a direction opposing the motion of the blade of the fan when in operation. The configuration with the attachment mechanism in the center of the underside of the collection pad 102 is beneficial when desiring to use the same air purification filter when the fan is operated in a first direction for a first thermal effect and changed to a second direction for a second thermal effect, such as during the change of seasons. This way, the partial lift is achieved no matter what direction the fan blades are rotating in. In other embodiments, the teeth side of the hook fastener can be coupled to an underside of the collection pad 102 wherein the teeth side of the hook fastener is adjacent to an edge of the underside of the collection pad 102. In such configurations, the adhesive side of the hook fastener is coupled to the fan blade adjacent to a trailing edge of the blade of the fan. In these embodiments, a larger partial lift is capable of being generated when the fan is powered on and more than half of the collection pad 102 undergoes facial lift in a direction opposing the motion of the blade of the fan when in operation. The hook fastener can be the attachment mechanism 202 as described in FIG. 2D.

In some embodiments, the hook fastener can be reinforced with an additional attachment mechanism, thereby further securing the collection pad 102 to the blade of the fan. For instance, the attachment mechanism can further include a plurality of buttons wherein each button of the plurality of buttons includes a male component and a female component. The male component is configured to be received and secured by the female component. Thus, in some embodiments, the male component of each button of the plurality of buttons is attached to the collection pad 102 and the female component of each button of the plurality of buttons is attached to the hook fastener wherein the collection pad 102 is further secured to the blade of the fan via the interaction between the male component and the female component of each button. In other embodiments, the female component of each button of the plurality of buttons is attached to the collection pad 102 and the male component of each button of the plurality of buttons is attached to the hook fastener wherein the collection pad 102 is further secured to the blade of the fan via the interaction between the male component and the female component of each button. The hook fastener with reinforcements can be the attachment mechanism 202 as described in FIG. 2E.

In some embodiments, the attachment mechanism includes a magnetic closure having a first magnet and a second magnet wherein the first magnet is coupled with the blade of the fan and the second magnet is coupled with the collection pad 102. In such embodiments, the magnetic closure is configured to secure the collection pad 102 to the blade of the fan via the magnetic pull between the first magnet and the second magnet. In other embodiments, the attachment mechanism comprises an anchor device connected to the blade of the fan having an insertion area and a locking portion wherein the insertion area is configured to receive the collection pad 102 and the locking portion is configured to secure the collection pad 102 within the insertion area.

FIGS. 2A-2F depict an air purification filter 200 having a collection pad 201 similar to the collection pad 102 described in FIGS. 1A-1B, and an attachment mechanism 202. The attachment mechanism 202 is attached to an underside of the collection pad 201 at approximately the center of the collection pad 201 and can be any of the attachment mechanisms previously described. For example, FIG. 2A illustrates an example attachment mechanism 202 that is an adhesive strip 214. The adhesive strip 214 may removably stick to the collection pad 201 and a fan blade. FIG. 2D illustrates an example attachment mechanism 202 that is a hook fastener 216. The hook fastener 216 may include an adhesive that sticks to the fan blade, and hooks that attach to the material of the collection pad 201. FIG. 2E illustrates an example attachment mechanism 202 that is a hook faster 216 and reinforcing buttons 218a,b. The hook fastener 216 may include an adhesive that sticks to the fan blade, and hooks that attaches to the material of the collection pad 201. Additionally, the hook fastener 216 could have buttons 218b that connect with buttons 28a on the collection pad 201, as previously described.

As such, FIG. 2D shows a partial lift of the collection pad 201 around the attachment mechanism 202. The lift could be created by the collection pad 100 moving through the air while attached to a fan blade. The attachment mechanism 202 can allow approximately half of the collection pad to lift from the surface of the blade of the fan when the fan is powered on and forces are acted on the air purification filter 200. This occurs because both long edges of the collection pad 201 are free to lift from the blade of the fan, as the attachment mechanism 202 does not extend beyond a central portion of the collection pad 201. Therefore, a leading half of the collection pad 201, being acted on by a force due to the wind when the fan is powered on, will be able to lift from the blade of the fan and capture more impurifications mid-air than would have been captured if the whole collection pad 201 remained in contact with the blade of the fan.

For instance, FIG. 2E shows a fan 204 having a first blade 206 coupled with the collection pad 201 via the attachment mechanism 202 (not shown), a second blade 208 comprising a second air purification filter, and a third blade 210 comprising a third air purification filter. In FIG. 2E the fan is powered off. However, when the fan is powered on, the air purification filter 200 will be able to partially lift, as is shown in FIG. 2F. Because the attachment mechanism 202 is at an approximate center of the collection pad 201, nearly half of the collection pad 201 experience this lift when the fan is powered on.

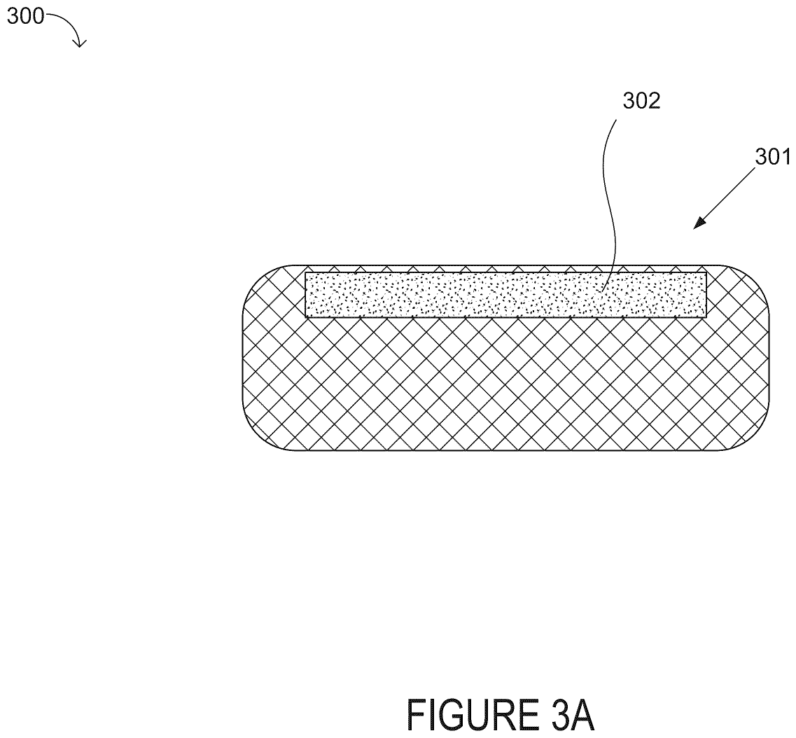

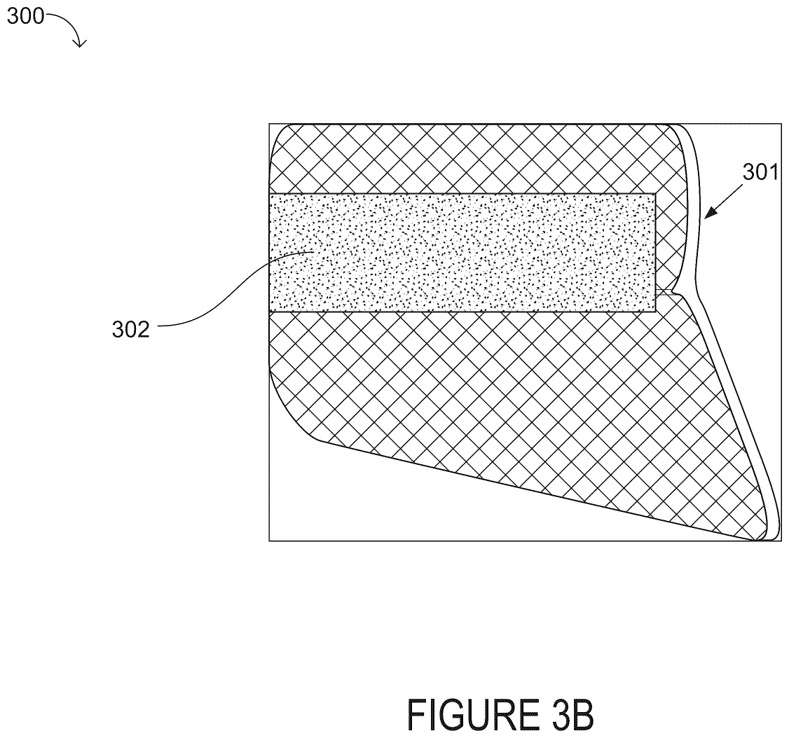

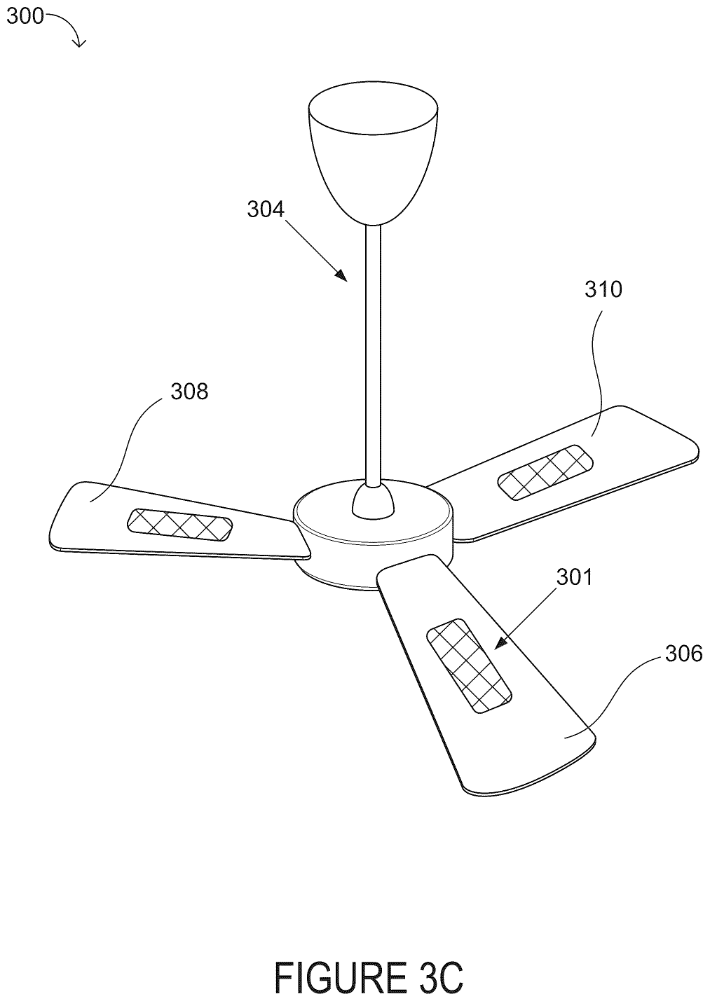

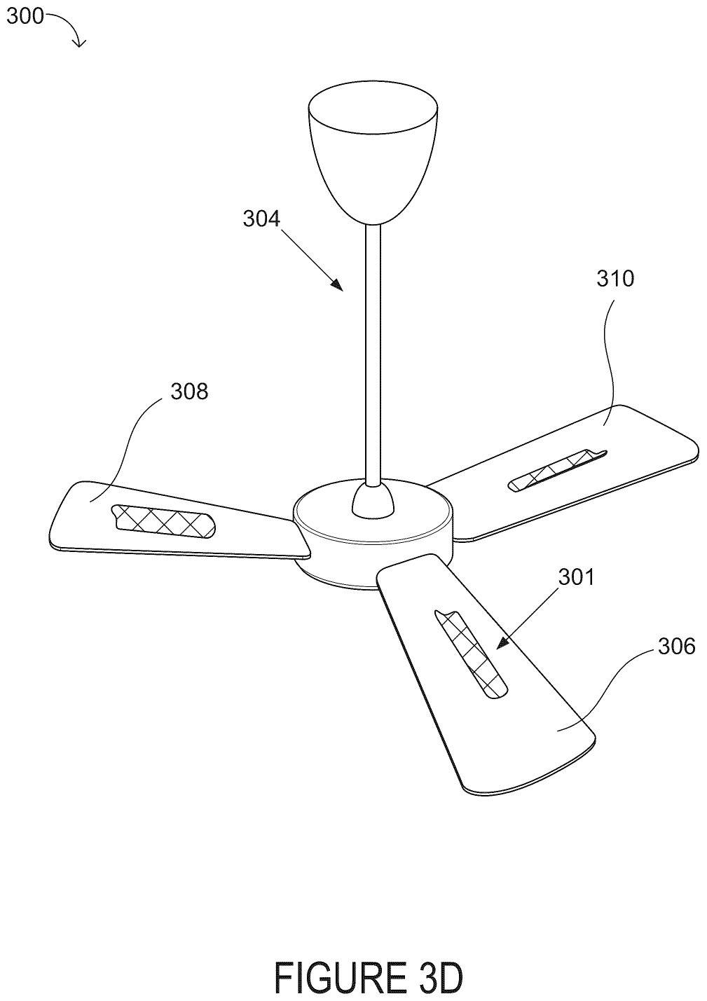

FIGS. 3A-3D depict an air purification filter 300 having a collection pad 301 similar to the collection pad described in FIGS. 1A-1B, and an attachment mechanism 302. The attachment mechanism 302 is attached to an underside of the collection pad 301 along a length of an edge of the collection pad 301 and can be any of the attachment mechanisms previously described and illustrated.

As such, FIG. 3B shows a partial lift of the collection pad 300 around the attachment mechanism 302. The lift could be created by the collection pad 301 moving through the air while attached to a fan blade. The placement of the attachment mechanism 302 can allow approximately ¾ of the collection pad to lift from the surface of the blade of the fan when the fan is powered on and forces are acted on the air purification filter 300. This occurs because the leading long edge of the collection pad 301 is free to lift from the blade of the fan, as the attachment mechanism 302 does not extend near the leading edge of the collection pad 301. Therefore, a leading ¾ of the collection pad 301, being acted on by a force due to the wind when the fan is powered on, will be able to lift from the blade of the fan and capture more impurifications mid-air than would have been captured if the whole collection pad 301 remained in contact with the blade of the fan, or if only half of the collection pad 301 remained in contact with the blade of the fan, such as is shown in FIGS. 2A-2F.

For instance, FIG. 3C shows a fan 304 having a first blade 306 coupled with the collection pad 301 via the attachment mechanism 302 (not shown), a second blade 308 comprising a second air purification filter, and a third blade 310 comprising a third air purification filter. In FIG. 3C the fan is powered off. When the fan is powered on, the air purification filter 300 will be able to partially lift, as is shown in FIG. 3D. Because the attachment mechanism 302 is at a trailing edge of the collection pad 100, nearly ¾ of the collection pad 301 can experience this lift when the fan is powered on. In such embodiments, the air purification filter 300 will experience greater lift than the air purification filter 200 described in FIGS. 2A-2F.

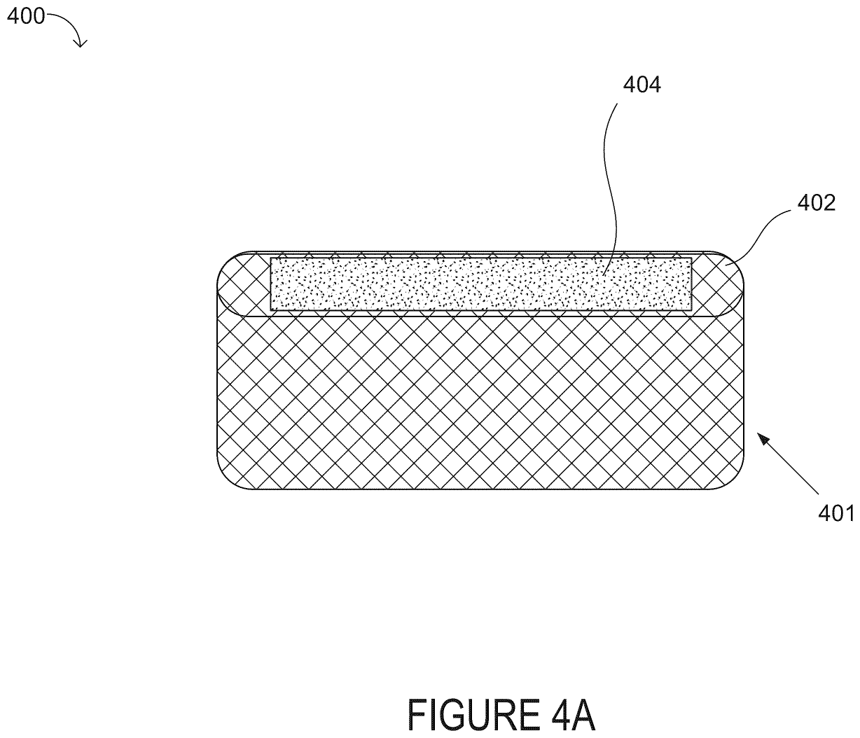

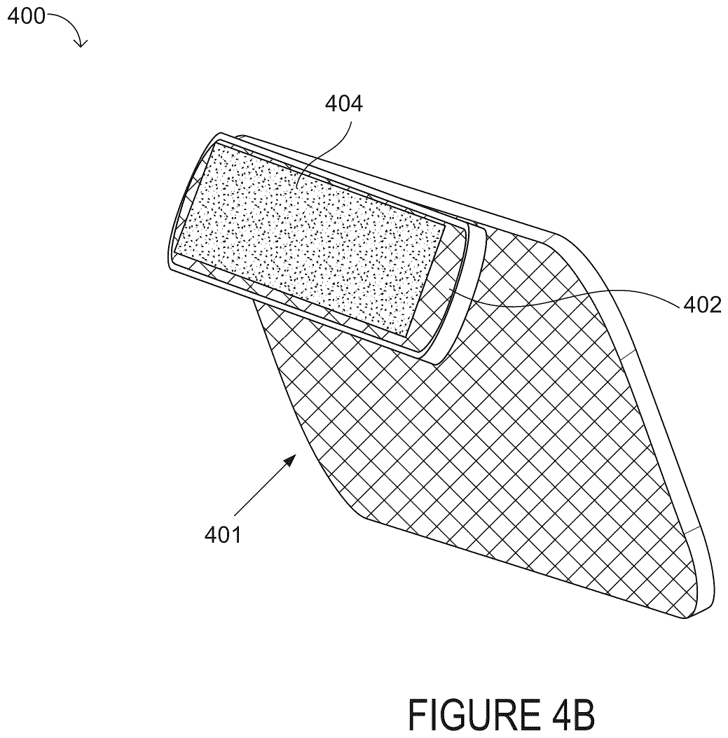

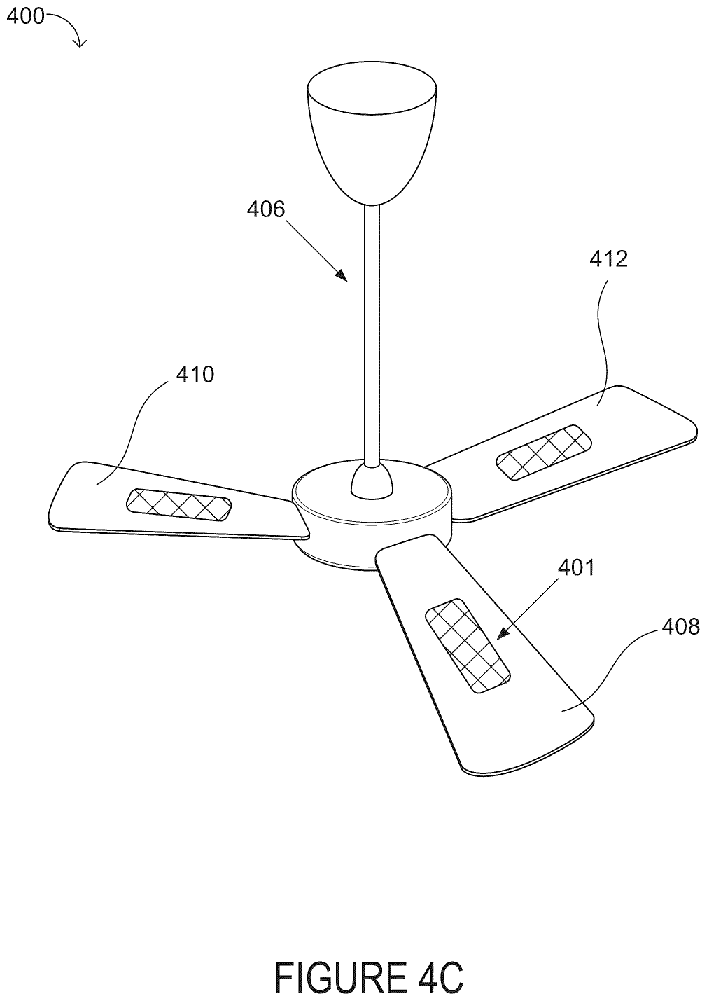

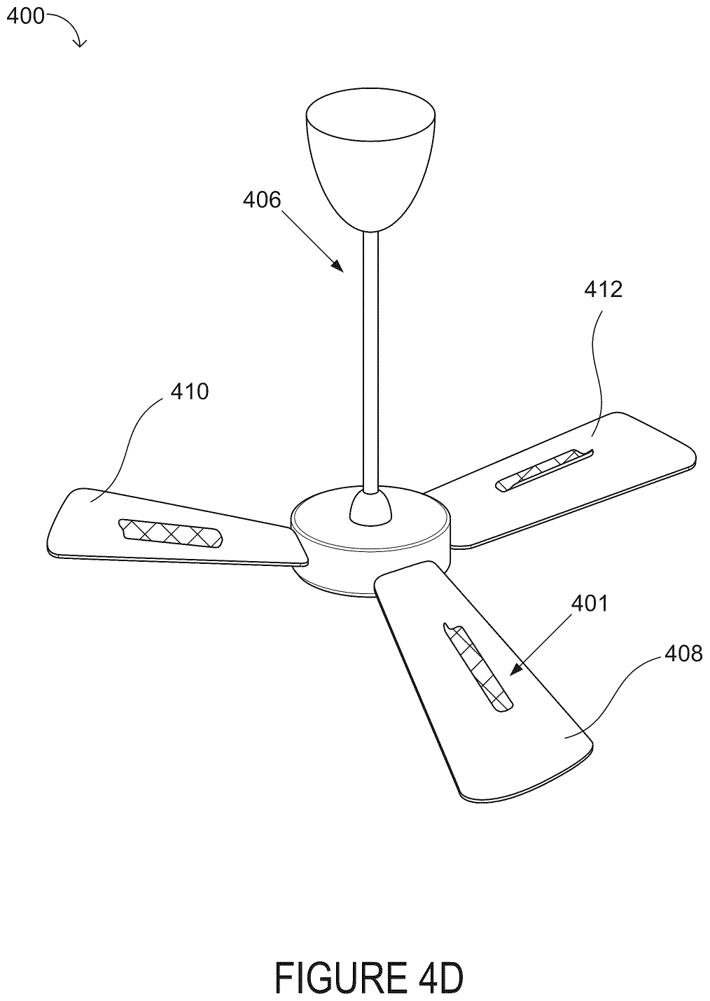

FIGS. 4A-4D depict an air purification filter 400 having a collection pad 401 similar to the collection pad described in FIGS. 1A-1B, a strip of impregnated polyester blend 402 attached to an edge of the collection pad 401, and an attachment mechanism 404. The attachment mechanism 404 is attached to the strip of impregnated polyester blend 402 along a length of an edge of the collection pad 401 and can be any of the attachment mechanisms previously described and illustrated.

In some embodiments, the strip of impregnated polyester blend 402 can have a length that is equal to or less than the length of the collection pad 401 and can have a width that is less than a width of the collection pad 401. As such, the strip of impregnated polyester blend 402 can be coupled with an edge of the collection pad 401 wherein the attachment mechanism is coupled to the collection pad 401 via the strip of impregnated polyester blend 402. In such embodiments, the collection pad 401 is configured to be rotatably-moveable around its edge relative to the strip of impregnated polyester blend 402. Accordingly, in some embodiments, the attachment mechanism is configured to be affixed to the fan blade adjacent to a trailing edge of the blade of the fan wherein, when the fan is powered on, the collection pad 401 can be rotatably-moved around its edge, creating maximum lift between the collection pad 401 and the blade of the fan, thus allowing for a greater surface area to be exposed to a greater number of contaminants in a single rotation of the fan.

As shown in FIG. 4B, the placement of the attachment mechanism 404 on the underside of the strip of impregnated polyester blend 402 can help create a partial lift of the collection pad 400 around the strip of impregnated polyester blend 402. The placement of the attachment mechanism 404 permits most of the collection pad 401 to lift from the surface of the blade of the fan when the fan is powered on and forces are acted on the air purification filter 400. This occurs because the entirety of the collection pad 401 is free to lift from the strip of impregnated polyester blend 402 and the blade of the fan, as the attachment mechanism 404 connects the collection pad 401 to the strip of impregnated polyester blend 402 rotationally. Therefore, the entirety of the collection pad 401, being acted on by a force due to the wind when the fan is powered on, will be able to lift around the attachment mechanism 404 at the strip of impregnated polyester blend 402 and capture more impurifications mid-air than would have been captured if the whole collection pad 401 remained in contact with the blade of the fan, or if only half or ¾ of the collection pad 100 remained in contact with the blade of the fan, such as is shown in FIGS. 2A-2F and FIGS. 3A-3D, respectively.

For example, FIG. 4C shows a fan 406 having a first blade 408 coupled with the collection pad 401 via the attachment mechanism 404 (not shown), a second blade 410 comprising a second air purification filter, and a third blade 412 comprising a third air purification filter. In FIG. 4C the fan is powered off. When the fan is powered on, the air purification filter 400 is able to partially lift, as is shown in FIG. 4D. Because the attachment mechanism 404 is connected to the strip of impregnated polyester 402 at a trailing edge of the collection pad 401, nearly all of the collection pad 401 can experience this lift when the fan is powered on, as the collection pad 401 rotates around the edge connection the collection pad 401 to the strip of impregnated polyester 402. Thus, the air purification filter 400 will experience greater lift than the air purification filters 200 and 300 described in FIGS. 2A-2F and 3A-3D, respectively.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. An air purification filter for attachment to a rotating fan blade comprising:
a collection pad comprising an impregnated polyester blend, wherein the collection pad comprises a plurality of perforations through which air is configured to pass upon rotation of the fan blade, and wherein the impregnated polyester blend comprises a blended polyester material embedded with an air purifying matter; and
an attachment mechanism coupled to the collection pad, wherein the attachment mechanism is configured to secure the collection pad to the fan blade.

2. The air purification filter of claim 1, further comprising:
a strip of impregnated polyester blend attached to an edge of the collection pad, wherein the attachment mechanism is coupled to the collection pad via the strip of impregnated polyester blend.

3. The air purification filter of claim 2, wherein the edge of the collection pad is along a length of the collection pad, and wherein the collection pad is configured to be rotatably-moveable around the length, relative to the strip of impregnated polyester blend.

4. The air purification filter of claim 3, wherein the attachment mechanism is configured to be affixed to the fan blade adjacent to a trailing edge of the blade of the fan.

5. The air purification filter of claim 1, wherein the attachment mechanism comprises a hook fastener, wherein the hook fastener comprises an adhesive side and a teeth side opposite the adhesive side, and wherein the teeth side is coupled to the collection pad and the adhesive side of the hook fastener is coupled to the blade of the fan.

6. The air purification filter of claim 5, wherein the teeth side of the hook fastener is coupled to an underside of the collection pad, and wherein the teeth side of the hook fastener is adjacent to a position at the center of the underside of the collection pad.

7. The air purification filter of claim 5, wherein the teeth side of the hook fastener is coupled to an underside of the collection pad, and wherein the teeth side of the hook fastener is adjacent to an edge of the underside of the collection pad, wherein the adhesive side of the hook fastener is coupled to the fan blade adjacent to a trailing edge of the blade of the fan.

8. The air purification filter of claim 5, wherein the attachment mechanism further comprises a plurality of buttons, wherein each button of the plurality of buttons includes a male component and a female component wherein the male component is configured to be received and secured by the female component, and wherein the male component of each button of the plurality of buttons is attached to the collection pad and the female component of each button of the plurality of buttons is attached to the hook fastener wherein the collection pad is further secured to the blade of the fan via the interaction between the male component and the female component of each button.

9. The air purification filter of claim 1, wherein the attachment mechanism comprises a magnetic closure having a first magnet and a second magnet, wherein the first magnet is coupled with the blade of the fan and the second magnet is coupled with the collection pad, and wherein the magnetic closure is configured to secure the collection pad to the blade of the fan via the magnetic pull between the first magnet and the second magnet.

10. The air purification filter of claim 1, wherein the attachment mechanism comprises an adhesive strip.

11. The air purification filter of claim 1, wherein the air purifying matter embedded in the impregnated polyester comprises activated coconut shell carbon.

12. The air purification filter of claim 11, wherein the activated coconut shell carbon comprises a surface area in excess of 1200 m²/gram.

13. The air purification filter of claim 1, wherein the air purifying matter embedded in the impregnated polyester comprises a zeolite.

14. The air purification filter of claim 1, wherein the air purifying matter embedded in the impregnated polyester comprises alumina potassium.

15. The air purification filter of claim 1, wherein the air purifying matter embedded in the impregnated polyester comprises a combination of a zeolite and activated coconut shell carbon.

16. The air purification filter of claim 1, wherein the collection pad has a length between 10 inches and 20 inches, and wherein the collection pad has a width between 3.5 inches and 5.5 inches.

17. The air purification filter of claim 1, wherein the collection pad has a thickness between ⅛ inch and 1 inch.

18. The air purification filter of claim 1, wherein the collection pad has a MERV rating between 5 and 10.

19. The air purification filter of claim 1, wherein each perforation of the plurality of perforations comprise a diameter configured to receive particulates between 0.1 to 100 microns large.

20. The air purification filter of claim 1, wherein each perforation of the plurality of perforations comprise a diameter configured to receive spores between 4 to 6 microns large.
